(19) United States
(12) Patent Application Publication
(10) Pub. No.: US 2015/0199443 A1
(43) Pub. Date: Jul. 16, 2015

(54) COMPUTER BASED AGENT REFERRAL SYSTEM, AND METHOD AND SYSTEM FOR COMMUNICATING INFORMATION IN RELATION TO A SUBJECT OF REFERENCE

(71) Applicant: RODRIGUEZ R. GABRIEL, Corpus Christi, TX (US)

(72) Inventor: RODRIGUEZ R. GABRIEL, Corpus Christi, TX (US)

(21) Appl. No.: 14/597,191

(22) Filed: Jan. 14, 2015

Related U.S. Application Data
(60) Provisional application No. 61/927,279, filed on Jan. 14, 2014.

(51) Int. Cl. G06F 17/30; G06Q 50/16

(52) U.S. Cl. CPC G06F 17/30867; G06F 17/30592; G06F 17/30377; G06F 17/3097; G06Q 50/16

(57) ABSTRACT

Embodiments provide a system and method for communicating information in relation to a subject of reference, the subject of reference characterized by referring information of a referring computing system, the subject of reference characterized by referred information of a referred computing system, the referring computing system 302 lacking omitted information, the omitted information including at least part of the referring information.

### CROSS-REFERENCE TO RELATED APPLICATIONS

This applications claims priority to U.S. Provisional Patent Application Ser. No. 61/927,279, filed Jan. 14, 2014, which is hereby incorporated by reference in its entirety.

### FIELD OF THE INVENTION

The disclosure relates to computer based systems and methods.

### SUMMARY OF INVENTION

In general, aspects of this disclosure are related to a computer-based system for referring agents, such as real estate agents, and handling one or more transactions associated therewith. While techniques disclosed herein are discussed with respect to real estate agents, it should be understood that the techniques can apply to other types of agents and/or relationships.

According to techniques of this disclosure, a computer-based system (referred to herein as “Platform”) can be an online, social referral engine for real estate agents (e.g., residential real estate agents, commercial real estate agents, or other types of agents). Platform can enable agents (e.g., licensed real estate agents and Realtors®) to refer business to each other using an online social tool that facilitates introductions to fellow agents.

Once a transaction is initiated, accepted and entered into Platform, the platform can manage the transaction until it is completed. Platform can ensure payment to the referring agent's broker. The referring agent can make a commission on each transaction that they initiate. In some examples, the referring agent may be awarded a commission in response to a successful closure of a transaction by a receiving agent. Platform can, in certain examples, manage collection of the commission due to the referring agent.

Payments to referring agents can be made to the referring agent's broker via a title company that handles the escrow of the property at hand. In certain examples, Platform can refrain from administering the commissions due to the receiving agent, leaving that responsibility to the broker.

In general, Platform can be considered a computer-based system for managing transactions, payments, and/or other aspects associated with agent referrals. The Platform system can include one or more computing devices, computer-executable instructions, communications networks, or other computer-based hardware and/or software for implementing techniques described herein. Accordingly, techniques of this disclosure can be implemented by a single computing device executing such computer-executable instructions, or can be distributed among multiple computing devices.

### BRIEF DESCRIPTION OF THE DRAWINGS

FIG. 1 depicts a flow chart delineating an exemplary embodiment of a method of the present disclosure.

FIG. 2 provides an illustrative representation an exemplary computing device.

FIG. 3 depicts a systematic overview of an electronically connected network capable of implementing the present disclosure.

FIG. 4 depicts screenshot of an agent comparison screen.

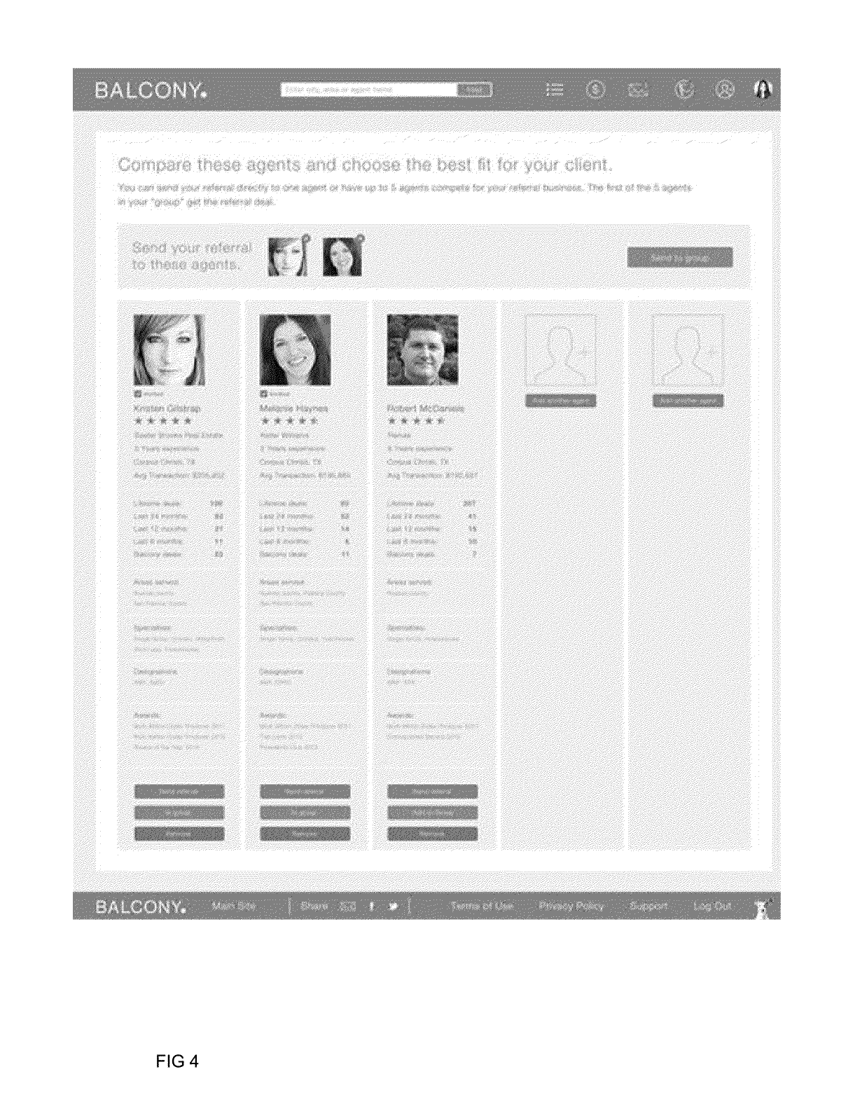

FIG. 5 depicts screenshot of an agent profile.

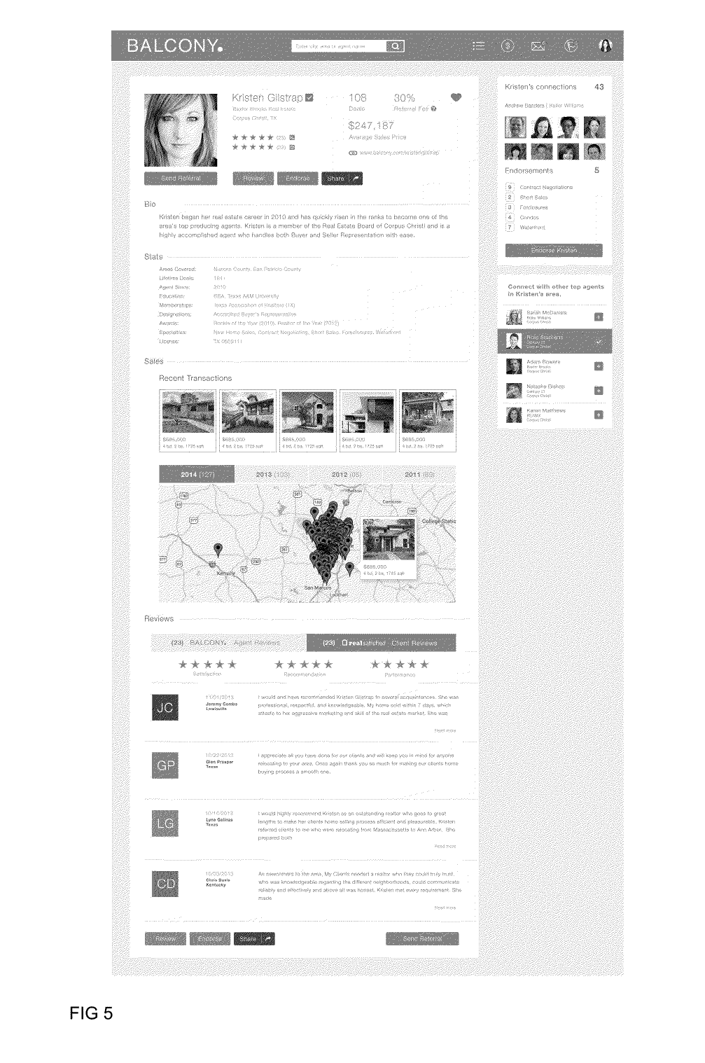

FIG. 6 depicts screenshot of client details once accepted.

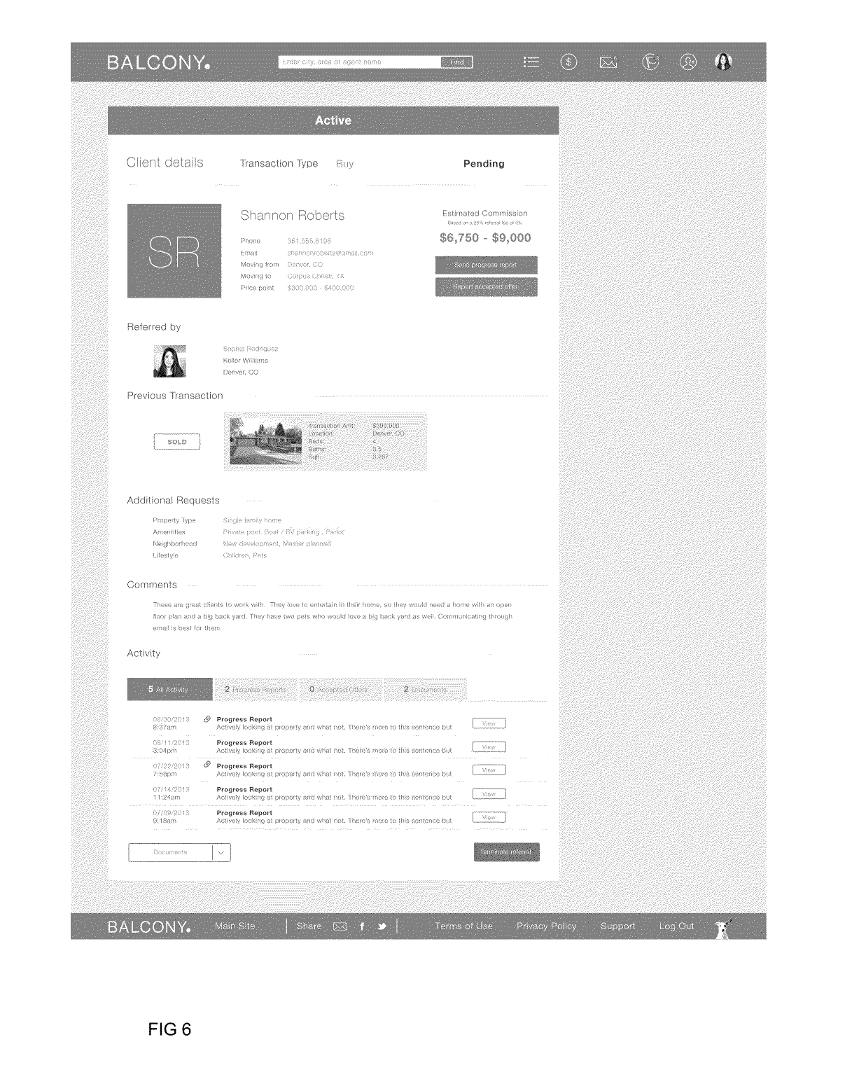

FIG. 7 depicts screenshot of a client list.

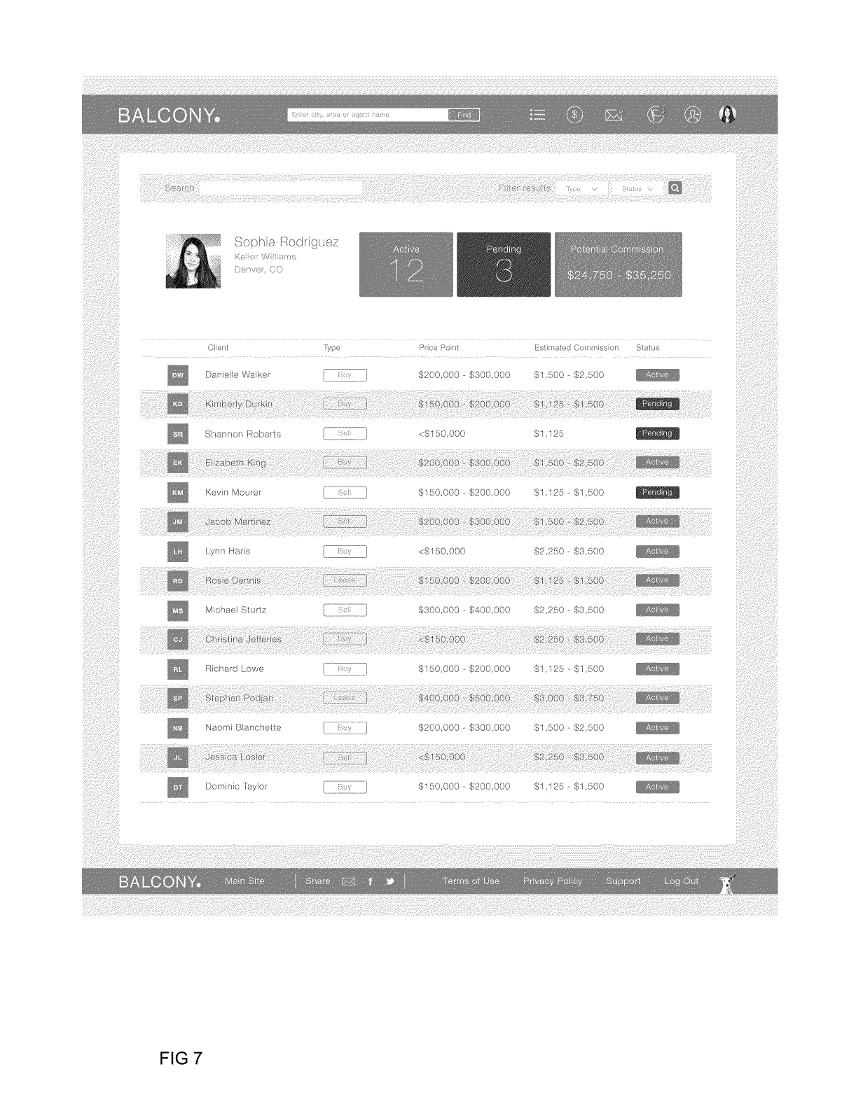

FIG. 8 depicts screenshot of an agent connections page.

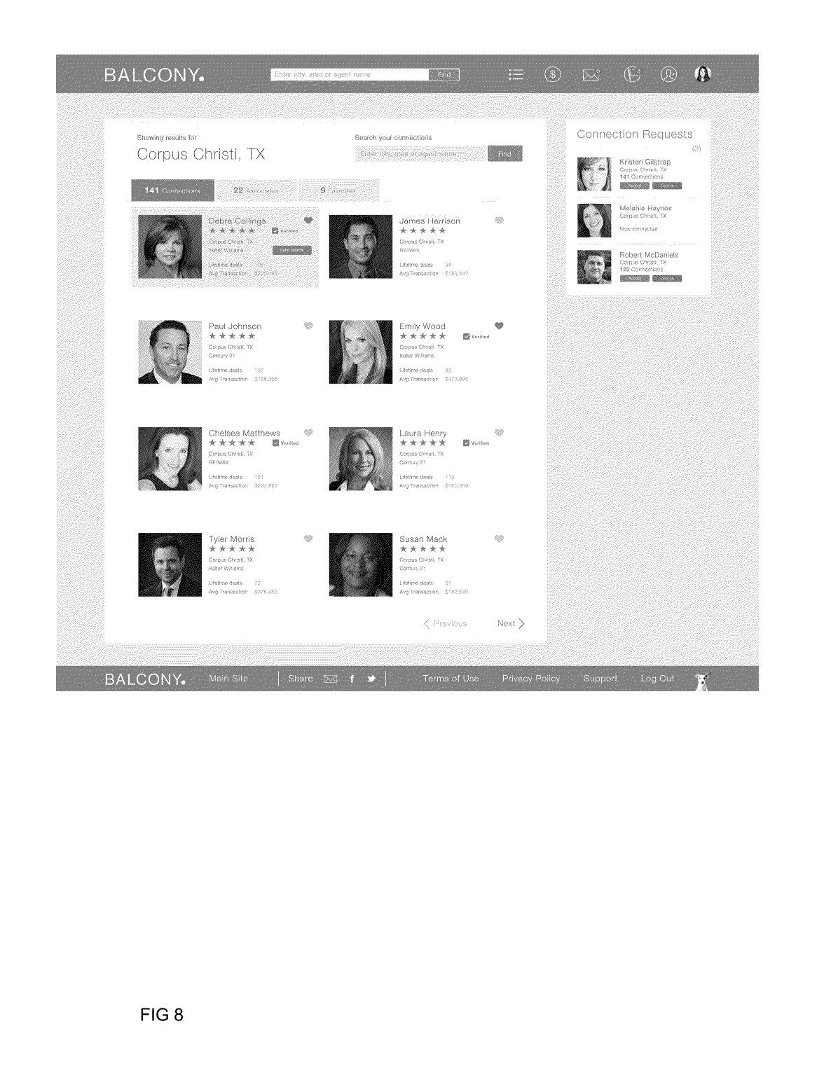

FIG. 9 depicts screenshot of the home search page.

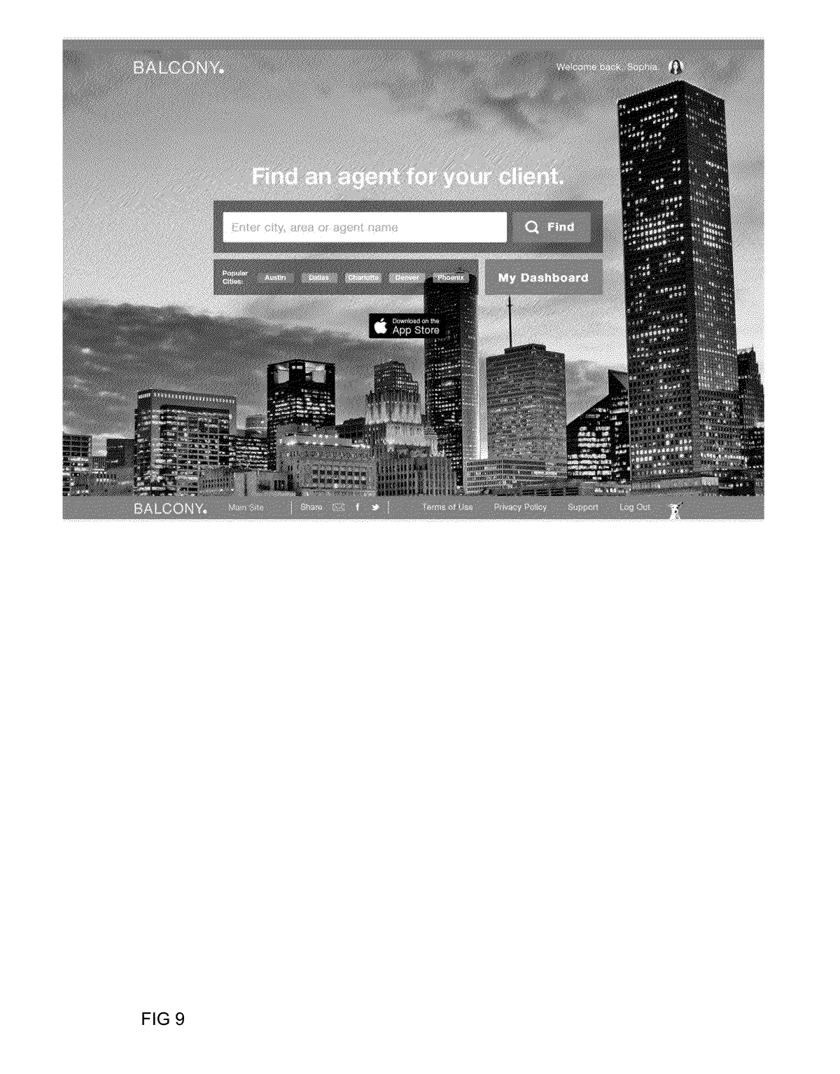

FIG. 10 depicts screenshot of a messages/notifications page.

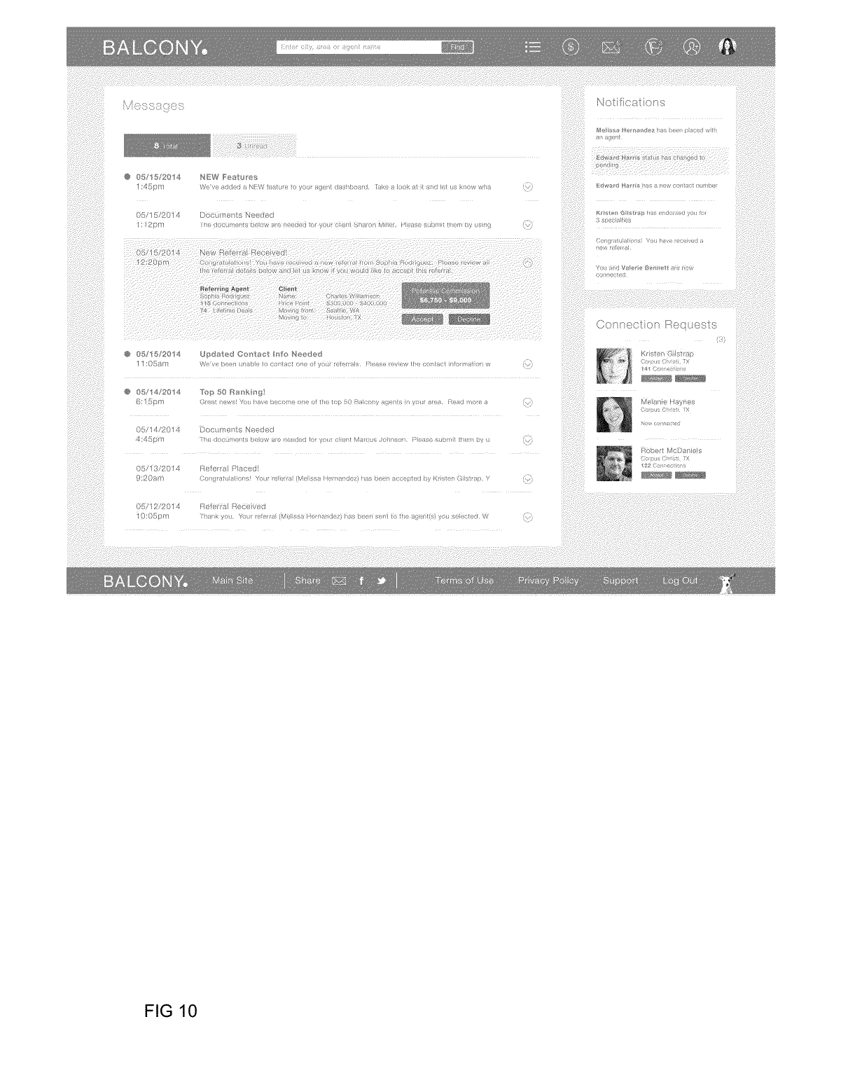

FIG. 11 depicts screenshot of a dashboard/newsfeed.

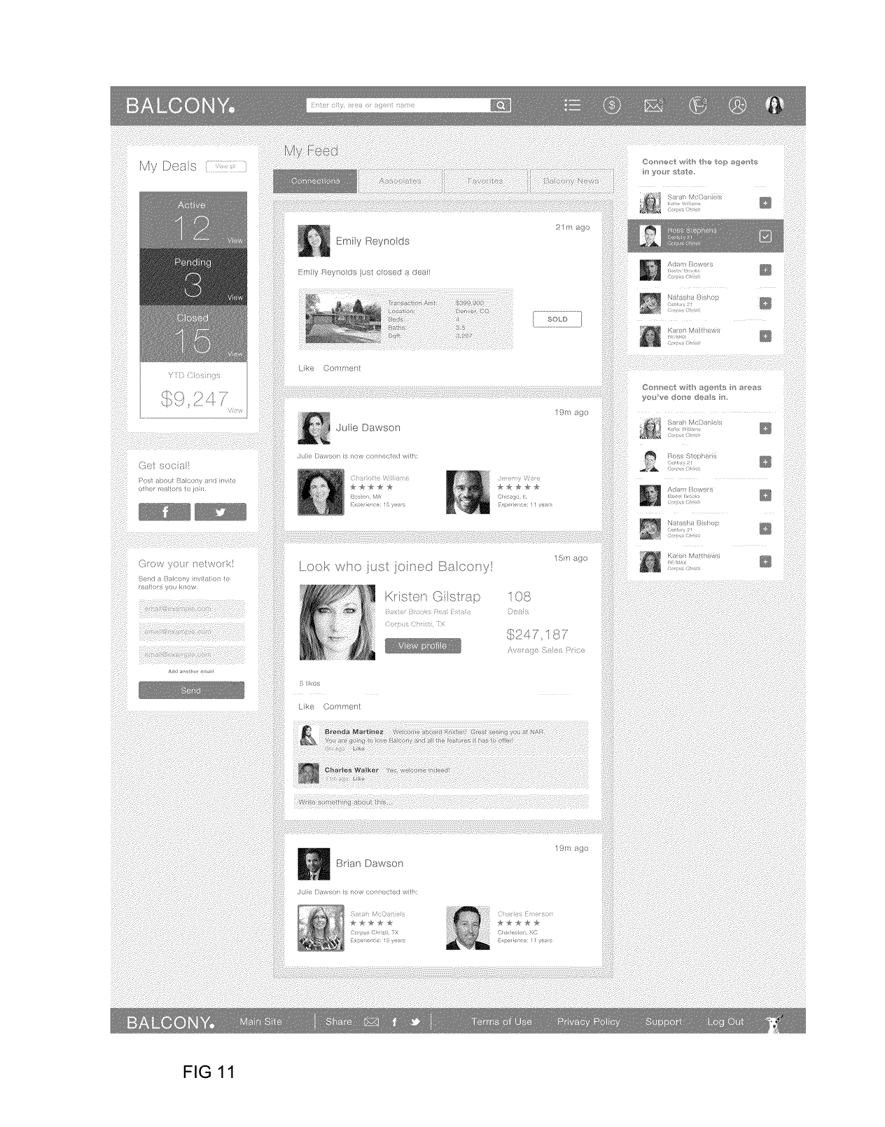

FIG. 12 depicts screenshot of a progress report submission.

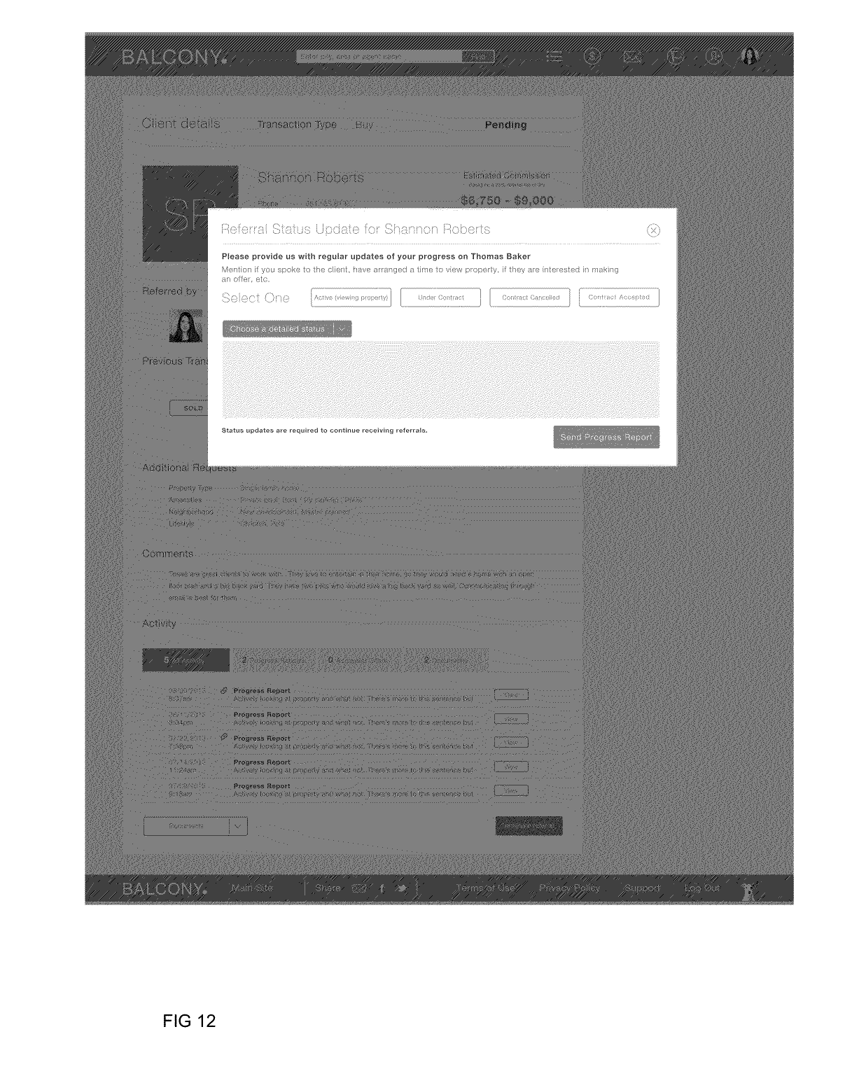

FIG. 13 depicts screenshot showing an agent's referral income.

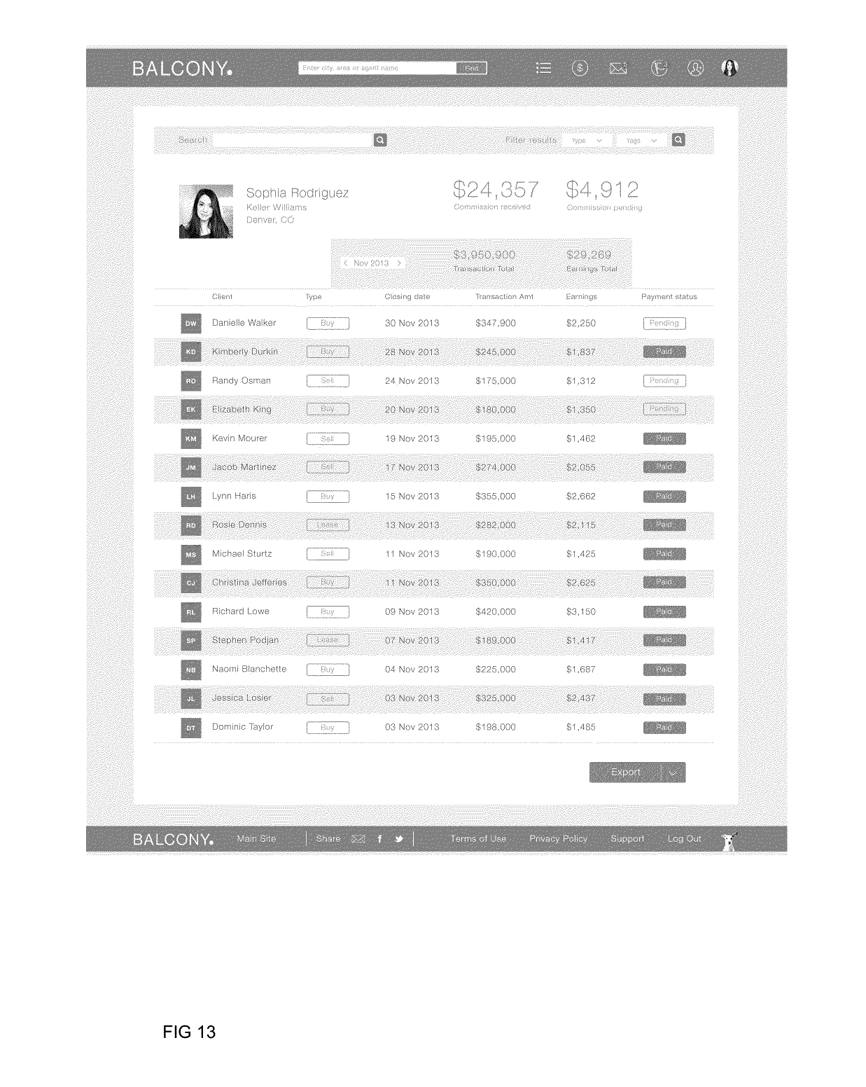

FIG. 14 depicts screenshot showing a received referral.

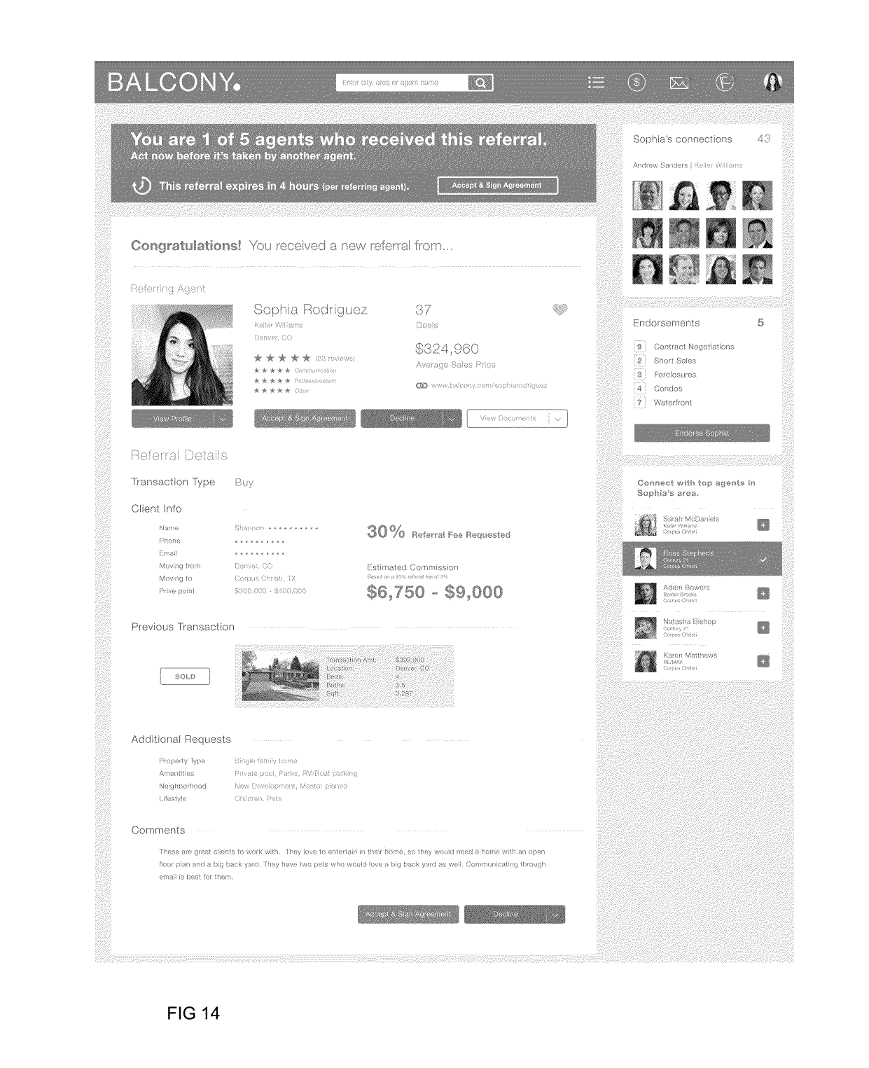

FIG. 15 depicts screenshot showing an accepted offer report.

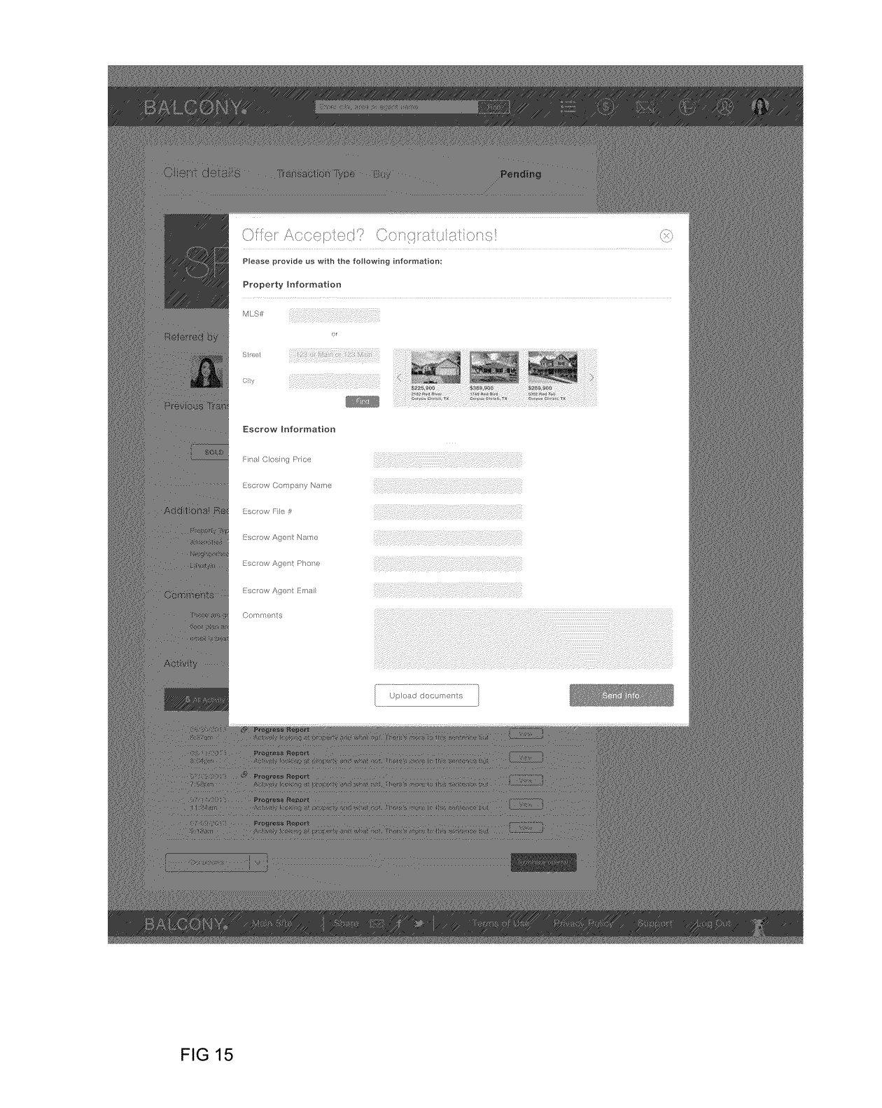

FIG. 16 depicts screenshot showing an agent's reviews and endorsements.

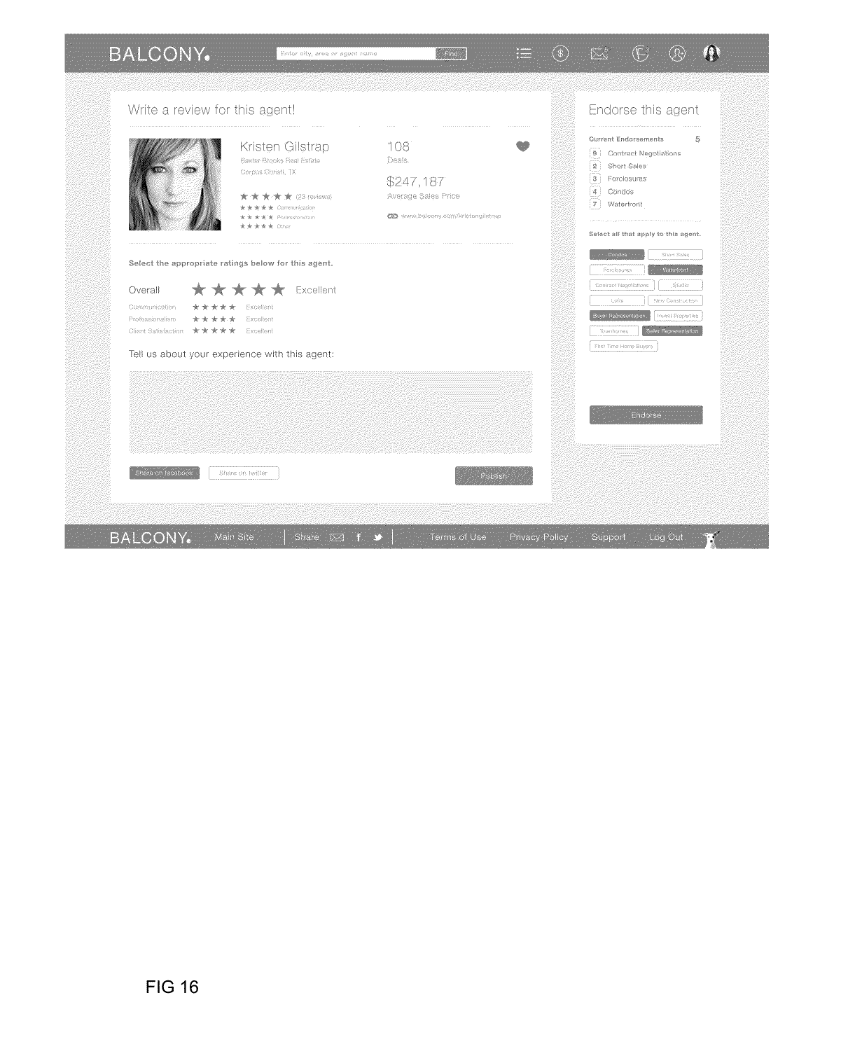

FIG. 17 depicts screenshot of agent search results.

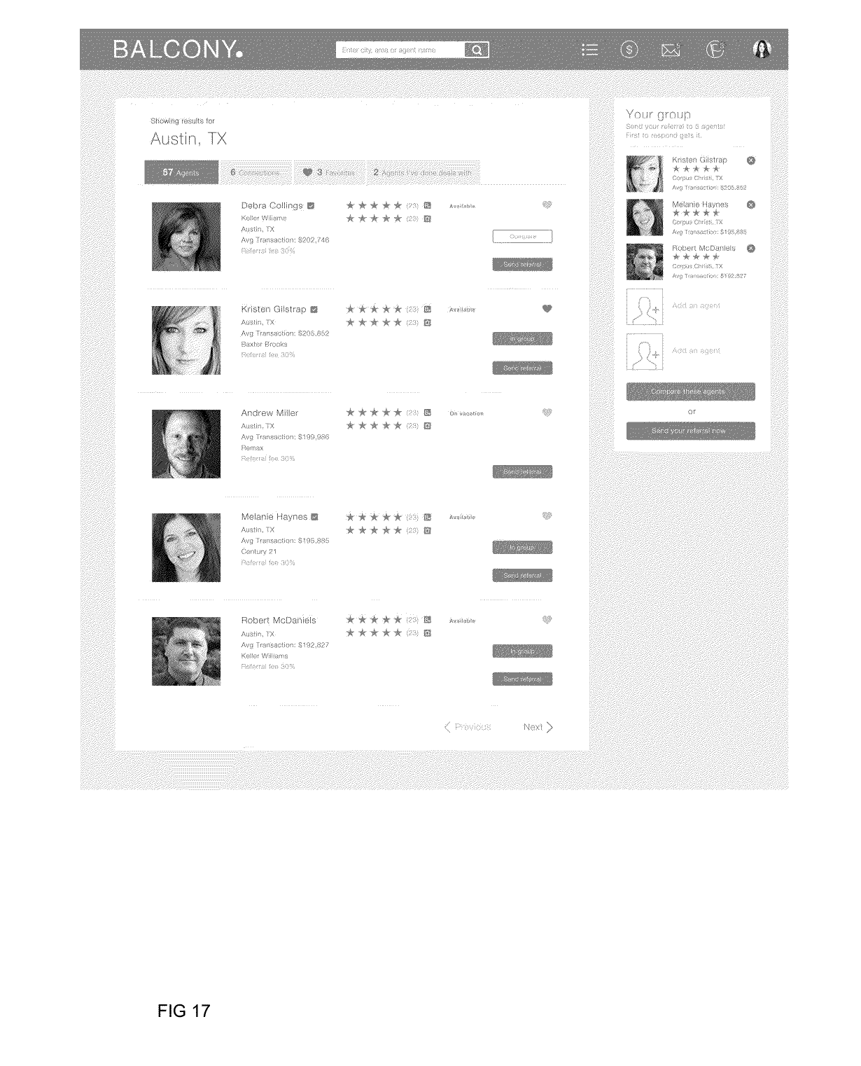

FIG. 18 depicts screenshot of potential referral information.

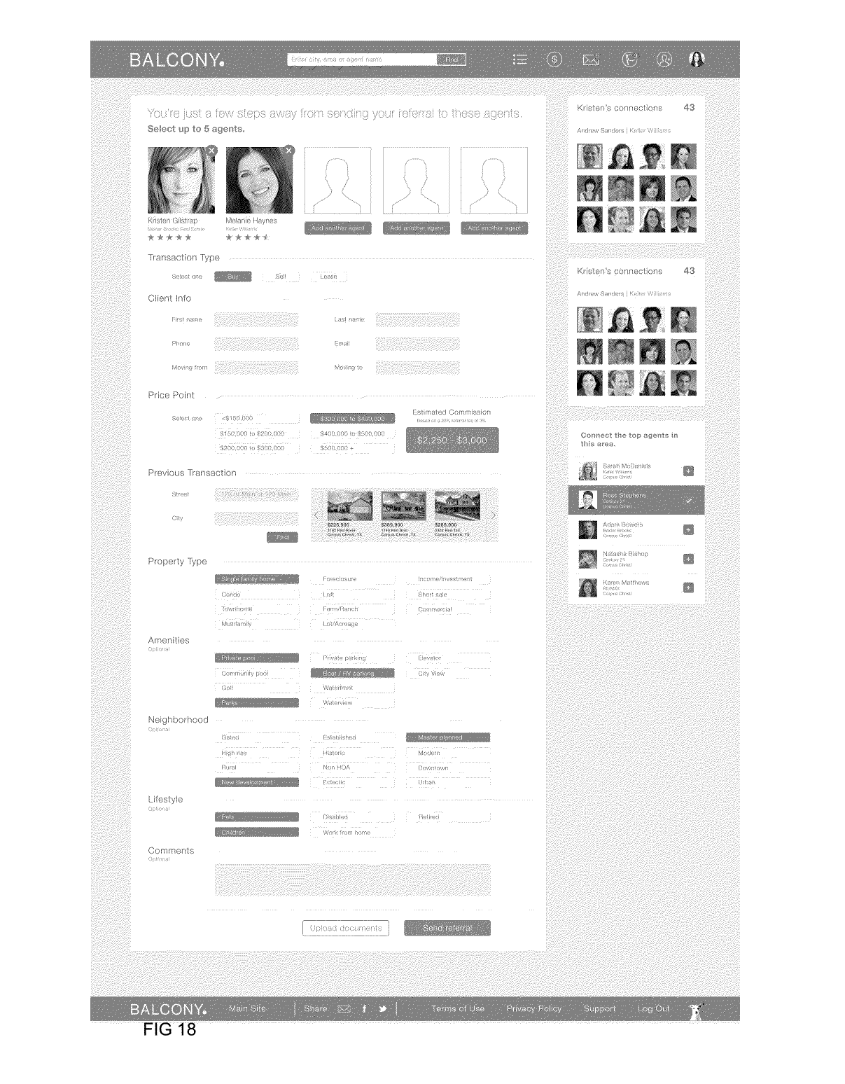

FIG. 19 depicts screenshot of a referral sending screen.

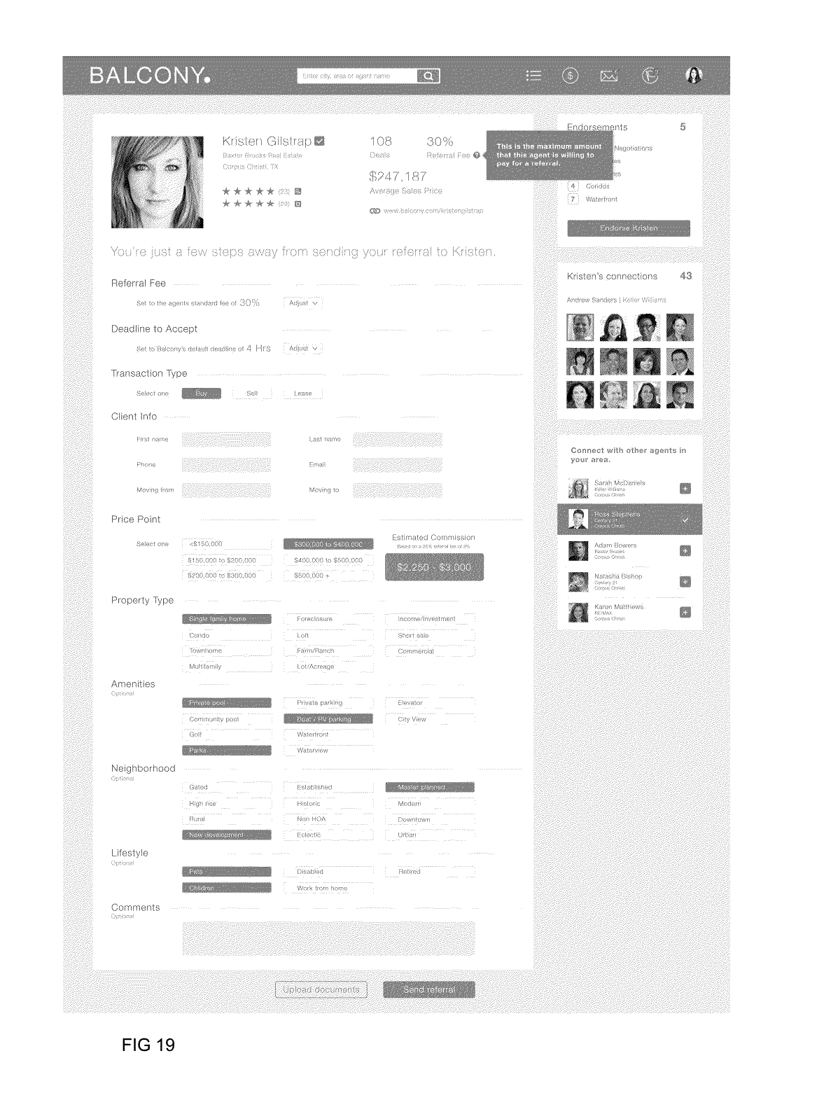

### DETAILED DESCRIPTION OF EMBODIMENTS

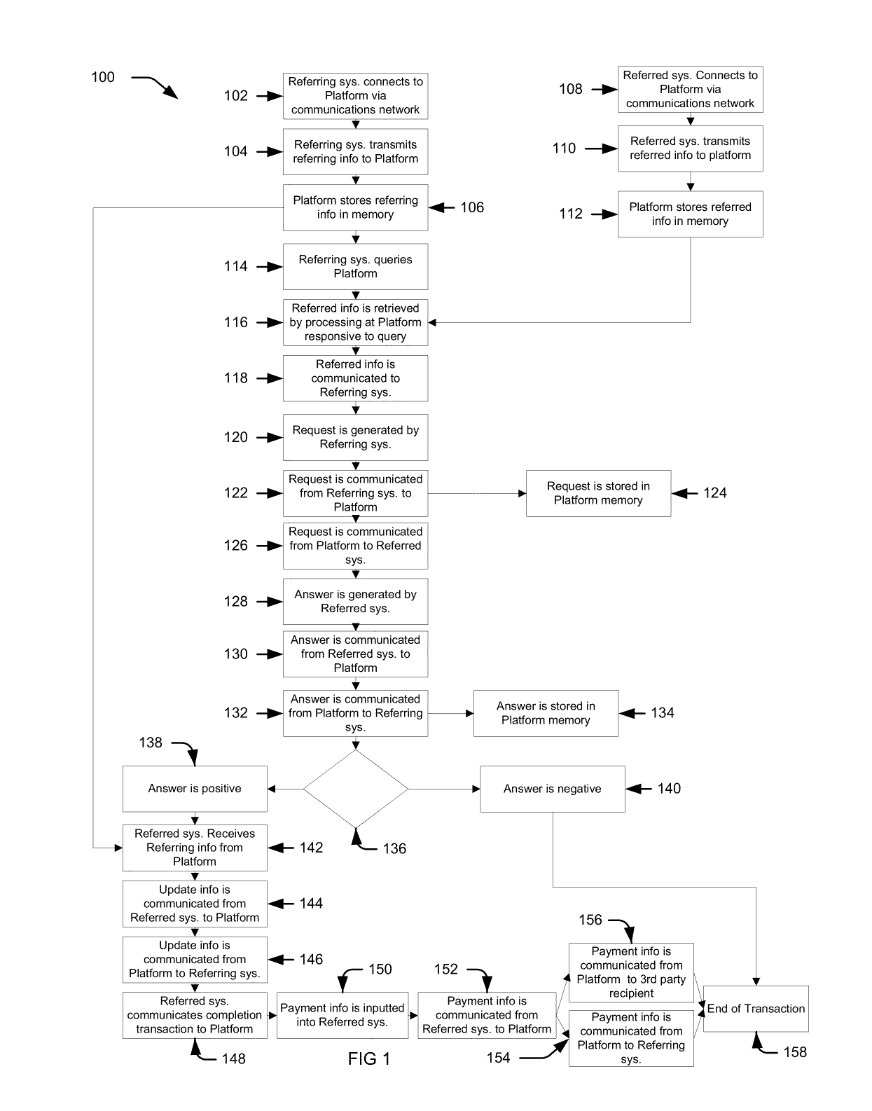

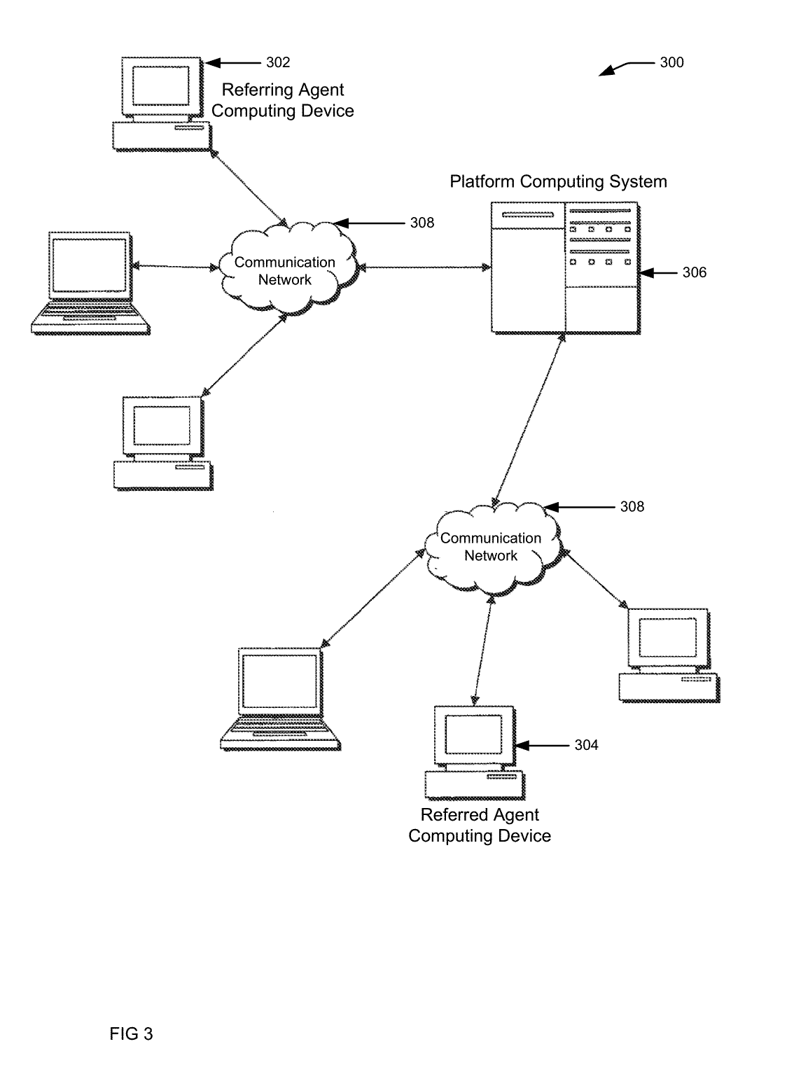

Referring to FIG. 1, in an embodiment a method 100 for communicating information in relation to a subject of reference, where the subject of reference characterized by referring information of a referring computing system (such as, for example, system 302 illustrated in FIG. 3). The subject of reference may be characterized by referred information of a referred computing system (such as, for example, system 304 illustrated in FIG. 3). The referring computing system may be lacking omitted information, the omitted information including at least part of the referring information, said method may include: first connecting 103 from a referring computing system to a platform computing system (such as, for example, system 306 illustrated in FIG. 3). Method 100 may include first communicating 104 from the referring computing system to the platform computing system at least part of the referring information. Method 100 may include first storing 106 at least part of the referring information in memory of the platform computing system. Method 100 may include second connecting 108 from a referring computing system to the platform computing system. Method 100 may include second communicating 110 from the referring computing system to the platform computing system at least part of the referred information. Method 100 may include second storing 112 at least part of the referred information in the memory of the platform computing system. Method 100 may include first querying 114 from the referring computing system to the platform computing system at least one first query criteria, the at least one first query criteria directed to at least part of the referred information. Method 100 may include first retrieving 116 at a processor of the platform computing system from referred information stored in the memory of the platform computing system retrieved information, the retrieved information meeting the at least one first query criteria. Method 100 may include communicating 118 from the platform computing system to the referring computing system returned information, the returned information being at least part of the referred information associated with the retrieved information. Method 100 may include first generating 120 a request by the referring computing system. Method 100 may include third communicating 122 a first request from the referring computing system to the platform computing system, the first request responsive to the returned information. Method 100 may include first storing 124 the first request in a memory of the platform computer system. Method 100 may include fourth communicating 126 a second request from the platform computing system to the referred computing system, the second request responsive to the first request. Method 100 may include generating 128 a first answer by the referred computing system. Method 100 may include fifth communicating 130 a first answer from the referred computing system to the platform computing system, the first answer responsive to the second request. Method 100 may include sixth communicating 132 a second answer from the platform computing system to the referring computing system, the second answer responsive to the first answer. Method 100 may include third storing 134 on the memory of the platform computing system a record of the second answer. Method 100 may include evaluating 136 whether the second answer is positive 138 or negative 140. Where the second answer is positive method 100 may include fourth storing 124 on the memory of the platform computing system a record of the first request. Method 100 may include a seventh communicating 142 from the platform computing system to the referred computing system at least part of the omitted information.

It will be understood by one skilled in the art that omitted information may include, for example, identity information of a perspective client who may seek to engage in a real estate purchase or sale transaction as a buyer or seller. It will be understood that the referring computer system may be a computing system associated with an agent for a buyer or seller. It will be understood that the referred computer system may be a computing system associated with an agent for a buyer or seller.

Referring again to FIG. 1, in an embodiment a method 100 for communicating information according to the preceding paragraph may further include: eighth communicating 144 from the referred computing system to the platform computing system update information, the update information including referred information. Method 100 may include ninth communicating 146 from the platform computing system to the referring computing system the update information. In an embodiment a method 100 for communicating information may further include the update information including referred information present in the referring computing system.

Referring again to FIG. 1, in an embodiment a method 100 for communicating information according to the preceding and further including: tenth communicating 148, 150, 152 from the referred computing system to the platform computing system event information (which may be, for example, information related to the completion of a transaction for real property, including, but not limited to, financial information such as information related to the payment of a referral fee), the event information relating to a first obligation resultant from the seventh communicating 142.

Referring again to FIG. 1, in an embodiment a method 100 for communicating information according to the preceding paragraph and further including: eleventh communicating 154 from the platform computing system to the referring computing system the event information, the event information relating to a second obligation resultant from the seventh communicating 142.

Referring again to FIG. 1, in an embodiment a method 100 for communicating information according to the preceding paragraph and further including: eleventh communicating 156 from the platform computing system to a recipient computing system the event information, the recipient computing system being other than the referring computing system (such as a brokerage computing system), the event information relating to a second obligation resultant from the seventh communicating 142.

In an embodiment a method for communicating information according to the preceding and further including: the at least one first query criteria including: geographic criteria.

In an embodiment a method for communicating information according to the preceding and further including: the at least one first query criteria including at least one of the following: geographic criteria, monetary criteria, real property characteristic criteria, referred agent characteristic criteria.

In an embodiment a method for communicating information according to the preceding paragraph and further including: the referred agent characteristic criteria including a rating of characteristic criteria.

In an embodiment a method for communicating information according to the preceding and further including: the platform computing system comprising a transaction processing subsystem, the transaction processing subsystem configured for processing documentation of a transaction for real property.

In an embodiment a method for communicating information according to the preceding and further including: the retrieved information being a subset of the referred information.

In an embodiment a method for communicating information according to the preceding and further including: the platform computing system configured to store a plurality of referred information, the plurality of referred information characterizing plural subjects of reference.

Illustrated in FIG. 3 is an exemplary embodiment of a system 300 operable for communicating information in relation to a subject of reference, the subject of reference characterized by referring information of a referring computing system 302, the subject of reference characterized by referred information of a referring computing system 302, the referring computing system 302 lacking omitted information, the omitted information including at least part of the referring information. Without limitation, in embodiments as shown in FIG. 3, system 300 may include a platform computing system 306 comprising a network adapter, the platform computing system 306 operable for communication via the network adapter over a suitable communication network 308 with the referring computing system 302, the platform computing system operable to receive from the referring computing system 302 a first communication including at least part of the referring information, the platform computing system operable to receive from the referring computing system 302 at least part of the referred information. Furthermore, as shown in FIG. 3, in embodiments system 300 may include the platform computing system including memory, wherein the memory may be configured for storing the at least part of the referring information, and wherein the memory may be configured for storing the at least part of the referred information.

Without limitation, in embodiments as shown in FIG. 3, system 300 may include the platform computing system comprising a processor in communication with the memory, the processor operable for processing information from the memory upon receipt of a first query from the referring computing system, the first query including at least one first query criteria directed to at least part of the referred information, the processor operable to perform processing in accordance with the first query from the at least part of the referred information stored in the memory to provide retrieved information, the retrieved information meeting the at least one first query criteria; the platform computing system operable to communicate to the referring computing system 302 returned information, the returned information being at least part of the referred information associated with the retrieved information; the platform computing system operable to receive from the referring computing system 302 a first request responsive to the returned information, the platform computing system operable to communicate to the referring computing system 302 a second request responsive to the first request; the platform computing system operable to receive from the referring computing system 302 a first answer responsive to the second request, the platform computing system operable to communicate to the referring computing system 302 a second answer responsive to the first answer; the platform computing system at the memory operable to store a record of the second answer, the platform computing system at the memory operable to store a record of the first request; and the platform computing system operable to communicate to the referring computing system 302 at least part of the omitted information.

According to embodiments, a system may include the platform computing system operable to receive from the referring computing system 302 update information, the update information including referred information, the platform computing system operable to communicate to the referring computing system 302 the update information. According to embodiments, a system may include the update information including referred information omitted from the referring computing system.

According to embodiments, a system may include the platform computing system operable to receive from the referring computer system event information, the event information relating to a first obligation resultant from the platform computing system communicating to the referring computing system 302 at least part of the omitted information.

According to embodiments, a system may include the platform computing system operable to communicate to a recipient computing system the event information, the recipient computing system being other than the referring computing system, the event information relating to a second obligation resultant from the platform computing system communicating to the referring computing system 302 at least part of the omitted information.

According to embodiments, a system may include the at least one first query criteria including geographic criteria. According to embodiments, a system may include the at least one first query criteria including at least one of the following: geographic criteria, monetary criteria, real property characteristic criteria, referred agent characteristic criteria.

According to embodiments, a system may further include the referred agent characteristic criteria having a rating of characteristic criteria. According to embodiments, a system may further include the platform computing system comprising a transaction processing subsystem, the transaction processing subsystem operable for processing documentation of a transaction for real property.

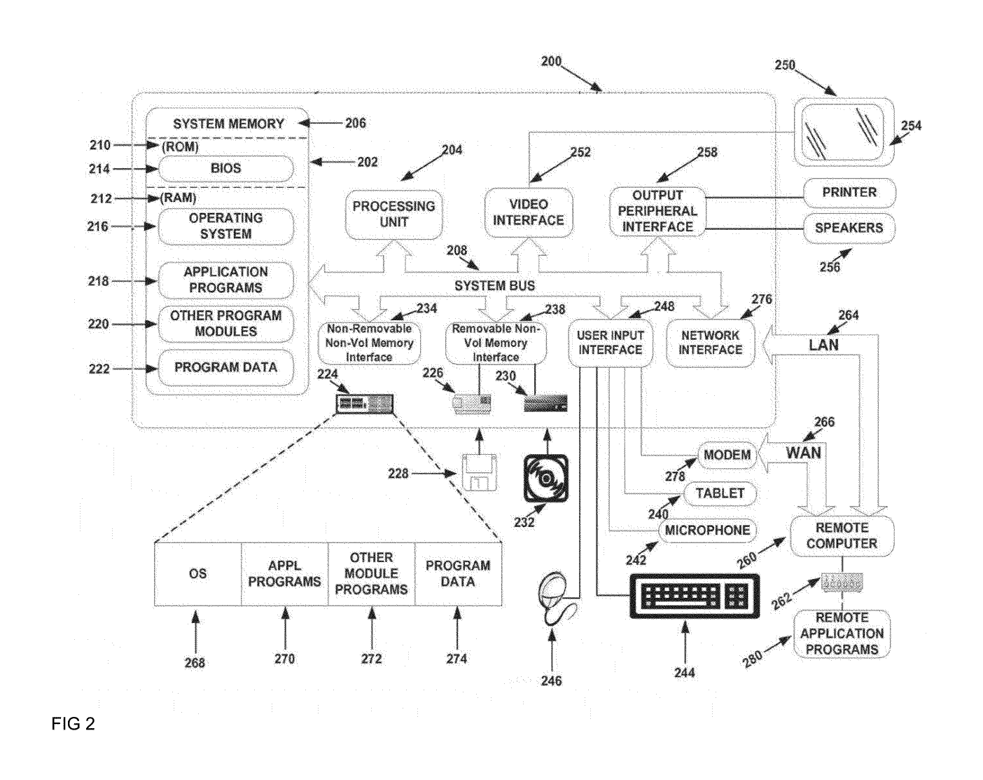

With reference to FIG. 2, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

Data shared and/or used in the various embodiments can also be shared and/or used via a traditional web site or to populate a web site (or other medium). This allows information already assembled in one or more of the other embodiments to be repurposed and thereby raise the value of the disclosed subject matter.

Examples of computing devices such as that depicted in FIG. 2 can include, but are not limited to, portable or mobile devices such as mobile phones (including smartphones), laptop computers, tablet computers, personal digital assistants (PDAs), or non-portable devices such as desktop computers, servers, mainframes, and the like. Such computing devices include, in some examples, various components, such as one or more processors, input devices, communication devices, output devices, storage devices, communications busses, or other components. Each of the components can be interconnected (physically, communicatively, and/or operatively) for inter-component communications. In some examples, the one or more processors of a computing device can execute an operating system that controls operations of components of the computing device, such as by facilitating communication between components of the computing device.

Processors of the computing device, in some examples, are configured to implement functionality and/or process instructions within the computing device. For instance, one or more processors of the computing device can be capable of processing instructions stored in one or more storage devices of the computing device. Examples of such processors can include any one or more of a microprocessor, a controller, a digital signal processor (DSP), an application specific integrated circuit (ASIC), a field-programmable gate array (FPGA), or other equivalent discrete or integrated logic circuitry.

One or more storage devices of a computing device can be configured to store information within the computing device during operation. Such storage devices can be described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, a storage device can be a temporary memory, meaning that a primary purpose of the storage device is not long-term storage. Storage devices, in some examples, can be described as volatile memory, meaning that the storage device does not maintain stored contents when power to the computing device is turned off. Examples of volatile memories can include random access memories (RAM), dynamic random access memories (DRAM), static random access memories (SRAM), and other forms of volatile memories. In some examples, a storage device can be used to store program instructions for execution by one or more processors. Storage devices, in certain examples, can be used by software or applications running on the computing device to temporarily store information during program execution.

Storage devices, in some examples, also include one or more computer-readable storage media. Storage devices can be configured to store larger amounts of information than volatile memory. Storage devices can further be configured for long-term storage of information. In some examples, storage devices can include non-volatile storage elements. Elements of such non-volatile storage elements can include magnetic hard discs, optical discs, floppy discs, flash memories, or forms of electrically programmable memories (EPROM) or electrically erasable and programmable (EEPROM) memories.

A computing device can, in some examples, include one or more communication devices. For instance, a computing device can utilize a communication device to communicate with external devices via one or more networks, such as wired or wireless networks or both. A communication device can be a network interface card, such as an Ethernet card, an optical transceiver, a radio frequency transceiver, or any other type of device that can send and receive information. Other examples of such network interfaces can include, but are not limited to, Bluetooth, 3G, 4G, WiFi radio computing devices, as well as Universal Serial Bus (USB).

In certain examples, a computing device can utilize a communications device to communicate with one or more external devices via a communications network. In some examples, components of Platform can be distributed among multiple computing devices, which can be interconnected via the communications network. Examples of such a communications network can include one or more wired or wireless networks or both, such as local area networks (LANs), wireless local area networks (WLANs), cellular networks, wide area networks (WANs) such as the Internet, or other types of networks.

A computing device can also include one or more input devices and/or output devices. An input device, in some examples, can be configured to receive input from a user. Examples of input devices can include any one or more of a mouse, a keyboard, a microphone, a camera device, a presence-sensitive and/or touch-sensitive display, or other type of device configured to receive input from a user. Output devices can be configured to provide output to a user. Examples of output devices can include a display device, a sound card, a video graphics card, a speaker, a cathode ray tube (CRT) monitor, a liquid crystal display (LCD) an organic light emitting diode (OLED) display, or other type of device for outputting information.

Accordingly, techniques of this disclosure can be implemented by one or more computing devices implementing computer-readable instructions that, when executed, cause the one or more computing devices to perform operations attributed to the Platform system. The Platform system is further described below within the context of various scenarios, illustrations, and further description.

### Scenarios

Scenario One: Veronica, the Referring Agent

Veronica is a successful real estate agent in Winnetka, Ill. She typically handles 30 transactions a year. Each transaction averages about $990,000. About 60 percent of her business is in listings (representing the seller) and the remaining transactions are in buyers.

Some 10-12 transactions total are the result of referrals from past clients or other agents in her local market, or from out of town agents. In total, 3-4 transactions (between buyers and sellers) were done with clients who were either moving elsewhere, or moving to Winnetka from locations more than 20 miles away.

Veronica is actively engaged in building her business, yet finds that it's difficult to manage her referral business when clients are either moving into, or out of, her regular “turf.” In these cases, it can be hard to ensure that she receives a commission referral check if she refers business to an out-of-town agent.

Moreover, it can be difficult to manage a client who is moving in, and ensure that the agent who refers business to her is adequately updated on her progress in selling the client a home. She doesn't have the time or inclination to provide constant transaction updates, although she's willing to do it if she recognizes that such updates make her money.

Veronica wants a service that delivers clients (not just leads) that's easy to use and ensures she gets paid for referring business to other agents.

Scenario Two: Fred, the Receiving Agent

Fred is a 37-year old newer agent in Seattle, although he handles lots of listings for his clients. He does about 20 deals a year, and considers himself an expert property marketer. His average transaction is about $450,000.

Fred gets about half of his business from repeat and referral clients, but wants to grow the referral side of his business. So he's created a profile on Platform, on the theory that advertising his listing acumen might get him more business from people who are moving into Seattle.

Fred wants a referral system that gives him business, but asks little in return. He's willing to give up a portion of his commission to the referring agent, but only if the referring agent can stay out of his hair. He's not interested in spending his time updating other agents, even if it might help him get more business via Platform. He thinks his reviews and profile should stand for themselves, and entice other agents to give him business.

Scenario Three: Osvaldo, the referring agent's broker

Osvaldo runs an independent brokerage in Sarasota, Fla. He has about 25 agents working for him. About 80 percent of the agency's production comes from just 20 percent of the agents. They are the agents who are moving the market forward, and Osvaldo loves them.

Except for one thing, Osvaldo would have it made: These same agents that move the market also refer business to agents outside Sarasota when clients move in or away. For Osvaldo, each piece of business that is referred should earn him a cut of the referring agent's commission. But all too often, the referrals are made informally, and the commissions are lost.

Osvaldo wants Platform because it will normalize and secure the referring procedure, and ensure that he and his agents get paid.

He likes looking at the broker dashboard, which rolls up all transactions connected to his agents so he can see which transactions are closing and payable. He also likes that deposits for commissions are electronically deposited in his account by Platform, and that he can see a statement of deposits in his account.

### Referring Agent

Referring agents are those agents that refer business to other agents. When a transaction closes, Platform can send their commission on the referred business to their broker, who then disburses the money to the referring agent. In some examples, such disbursement of money can be accomplished outside of the Platform system. In other examples, the Platform system can be utilized for such disbursement.

### Receiving Agent

Receiving agents get referrals through referring agents on Platform. They can accept referred business from a Platform referring agent once they have signed a master referral agreement. Once they get and accept a referral from a referring agent on Platform, their obligation is to service the referred client until a transaction is closed. Along the way, they need to update the referring agent about the status of the transaction and inform their title company that Platform is servicing the referred client.

### Referring Broker

Referring brokers can be attached to (e.g., associated with) referring agents on the Platform. Agents give a portion of their referral commission to their broker (i.e., the respective broker associated with the agent). Brokers may have many agents working for them, each with an individual split. Some brokers may be working real estate agents as well, in which case they may also be tagged as referring or receiving agents within the Platform.

### Client

Clients can be considered the customers of referring agents. In some examples, clients do not have direct access into the Platform, although they may receive contact from Platform staffers to ensure that the receiving agent is providing quality service. Bad clients can be flagged by agents or brokers. One client may work with many agents.

### Agent Transaction Coordinator

Transaction coordinators may work with either type of agent on a transaction. They can be connected to an agent, and may not have full privileges unless they are associated with a vetted agent.

### Platform Transaction Manager

Platform transaction managers can administer any type of account on the platform. They can create, add to, edit, delete or block accounts. In some examples, transaction managers are prevented from moving money.

### Platform Administrator

Platform administrators can be considered “super users”. They can create, add to, edit, delete or block accounts. They can manually approve individual agents' accounts (with respect to vetting). They can create demo accounts. They can move money between accounts, adjust reporting about money, or manually release funds.

### Title/Escrow Company

Title/escrow companies can release commissions resulting from closed transactions to the Platform.

### Document Processing

Document processing enables referring agents to send referral agreements to receiving agents, and manages the process to ensure all paperwork is signed and legally enforceable.

### Payment Processor

Payment processing disburses funds to referring brokers after monies are received from title/escrow companies.

### Referring Agent Functionality

Referring agents can perform four major tasks on Platform:

They can create an account and profile for themselves on the platform.

They can network with other agents, connecting and interacting with them on a professional basis, much like LinkedIn. They can also invite other agents into the platform.

They can refer business to other agents, either by selecting an agent they already know on the platform, or via searching to compare and select agents outside their network. Agents can refer and receive clients, and may be on both sides of different deals at the same time. They can create profiles of their clients when they are referring business to other agents.

They can review other agents with whom they've done a transaction. They can also ask for reviews.

### Agent Profile

The agent profile can enable an agent to network with other agents and to sell themselves. Example functions can include:

Public vs. Private Profiles: Agents can have two types of profiles by default. Public profiles exclude contact details including email and telephone numbers. You can see contact details once you are connected.

Rich media: Agents can upload pictures and video to populate their profiles.

Transaction history: An average deal score can be calculated based on the last 10 deals from the agent's MLS

Latest Listings: Agents can showcase their last three listings within their profile that are pulled from the MLS.

Visible networks: Agents can see whom they're connected to, and see suggestions to meet other agents on Platform (a “you might also know” or suggestion function). Other Platform users can be presented that have viewed an agent's profile.

Reviews: Agents can show or hide reviews of their services from other agents.

Other Networks: Agents can connect other networks, such as other social networks, so that they can publish Platform updates to other platforms.

Agents can customize their profiles to display or suppress certain statistics, MLS listings or other items that they view as controversial.

Tabs and/or modules display certain categories of information (for example, listings or reviews)—if the information isn't there, it's suppressed (it just doesn't exist).

### Account Settings

Agents can:

Set privacy choices

Set communications preferences, e.g., text, emails

Set up and invite their broker into Platform

Change their company name and broker, thus replacing any existing agreement with old broker with a new agreement

Manage their account contact details

Add an agent transaction coordinator to their account

Cancel their account

Submit a support ticket

Master Referral Agreement

The Master Referral Agreement can be signed as part of the on-boarding process with the new agent coming onto the Platform.

### Friends and Networking

Agents can:

Add their friends from other social networks on a selective basis (meaning that the Platform system can, by default, include each contact (or “friend”) as an option while enabling a user choose from a list as to who to invite).

Connect to other social networks to post content to them

Block other Platform Users

Connect to or disengage from other users

Report other users for inappropriate behavior or unethical practices

See a feed of friends' updates and transaction status on their home page

### Clients

Agents can:

Create, edit, delete client profiles

Expected transaction price

Client demands (type of property, square feet, neighborhood, etc.)

Narrative description of client's preferences, character, needs and desires

Agents on either side of the deal can terminate a referral. In some examples, a human Platform transaction manager can be required to intervene to terminate.

Data about the referral can be associated with the referring agent. It's can be considered an agent asset that belongs to the person who put it into the system.

### Transaction Reporting

Agents can:

See a rollup report of their transactions, to include line items with client name, location and status (open, closed, pending). You can drill into each transaction to see the details for each client:

Deals in process include:

Projected commission

Status updates from receiving agent

Contact details for receiving agent

Client contact details

Title company contact details

Ability to flag transaction for suspicious activity

Closed deals include everything from the deals in process, as well as:

Actual commission

Payment status with tracking information

Ability to dispute a transaction payment

Account On-boarding Quality Assurance

Platform can ensure that certain elements of the account profile are properly completed so that new agents can do business on Platform. The platform can trigger certain automatic emails, and escalate certain types of activities to humans at Platform for remediation. Examples can include:

Master referral agreement incomplete (triggered email)

Incorrect NERDs ID or MLS (triggered email, followed by human intervention)

Incomplete profile (triggered email)

Social and Transaction Updates

Agents can update their profile with news and information about their transactions, clients and business. Generally, these will fall into three categories:

Professional achievements, Platform success stories, updates/messages for other agents

New Listings

Specific Platform transaction details

These posts can contain links, photos, videos and text. Posts may be made on the website or via the mobile app. Other users may flag posts as inappropriate. In this instance, a Platform transaction manager can be notified. Users who are connected to each other can see each other's posts in their newsfeed. Platform can also be able to insert its own posts in the feed. Users can hide posts they don't like or want to see from other users. In certain examples, users are prevented from hiding Platform posts.

### Receiving Agent Functionality

Receiving agents can do everything referring agents can do on Platform, but have some additional responsibilities:

They can accept referrals if they are a vetted member of Platform in good standing, and have signed a master referral agreement with the referring agent and broker.

The can post periodic updates about client transactions back to referring agents; these are typically timed to major events within a contract, such as writing an offer, accepting an offer, entering escrow or closing a transaction. In some examples, receiving agents are required to post such updates.

They can (and, in some examples, are required to) add the title company for a specific transaction so that the commission can be paid by the escrow officer to Platform.

### Transaction Process

Agent accepts referral from referring agent via Platform

Platform sends both agents an email documenting transaction and confirming agents' contact details

Receiving agent receives transaction referral agreement, signs, and returns document electronically to broker for signature; countersigned document is associated with transaction record

Receiving agent receives full client contact details

Receiving agent initiates contact with client offline

Receiving agent's first status report is due: Is this client going to work with the agent?

Receiving agent continues deal process; makes offers, gets an offer accepted, enters escrow; submits status reports for each step via direct post to platform, SMS, email or mobile application

Receiving agent enters title company contact details into Platform

At major deal events, a real person from the client care team at Platform can call or email the client to check progress and to ensure satisfaction.

Platform sends countersigned agent referral agreement to escrow officer

Escrow officer pays Platform out of settled funds (may be electronic or hard check)

Platform pays referring broker

Broker pays referring agent

Transaction Process Variables

Transaction length—it might take months for an agent to conclude a transaction

Cancellations—a client might drop out of the process

Termination—an agent might terminate a referral, in which case Platform can be notified

Fraud—agents might decide to go outside of Platform to avoid Platform's commission

Transaction Process Variables

Platform can monitor the transaction from the moment it is initiated to the final payment to the referring broker. The platform can (and, in some examples, is required to) trigger certain automatic emails, and escalate certain types of activities to humans at Platform for remediation. Examples can include:

Not sending status reports (triggered email)

Sending inappropriate/incomplete status reports (triggered email)

Referral agreement not returned/countersigned (triggered email, then human intervention)

Being flagged by another agent or broker for inappropriate, fraudulent or suspicious behavior (human intervention)

Negative client feedback acquired by Platform client care team from a deal in process (human intervention)

Payment disputes (human intervention)

Referral termination (human intervention)

### Referring Broker Functionality

Referring brokers can be (and, in some examples, are required to be) tied to at least one referring agent. In some cases, the referring broker may also be an agent, though it's more likely that a referring broker would have multiple referring and receiving agents.

Referring brokers make money when referring agents sell a house. Referring brokers are entitled to a cut of their agents' commissions. This cut is called the “split.” The split can vary from agent to agent and brokerage to brokerage. Some agents will have different splits with their broker, even within the same brokerage.

However, whatever the agent's split is with his broker, Platform's deal structure can remain the same. Thus, Platform can merely report on the transaction and pay the referring broker on a cut of the referring agent's transaction in Platform.

Referring brokers can originate accounts, as well as accept invitations onto the platform from individual agents. They can also:

See a rollup report of their receiving and referring agents' transactions, to include line items with client name, location and status (open, closed, pending). You can drill into each transaction to see the details for each client:

Deals in process include:

Projected commission

Status updates from receiving agent

Contact details for receiving agent

Client contact details

Title company contact details

Ability to flag transaction for suspicious activity

Closed deals include everything from the deals in process, as well as:

Actual commission

Payment status with tracking information

Ability to dispute a transaction payment

Add a team of agents, either one by one or en masse. Thus, if a broker opens an account with Platform, he may choose to add all of his agents at once to the platform. At this point, he won't know whether they're receiving or referring agents; he'll just know that they're able to give and get referrals. When an agent is brought on to Platform in this way, the system can notify agents to complete their profile.

See a directory of his agents on Platform, with the ability to add, edit or delete agents. However, in some examples, if an agent is currently in an active deal, the Platform system can prevent the agent from being deleted.

Receive, sign and submit master referral agreements

### Transaction Reporting

Brokers can:

See a rollup report of their referring and receiving agent transactions, to include line items by deal with the referring or receiving agent's name, client name, location and status (open, closed, pending). You can drill into each transaction to see the details for each client:

Deals in process include:

Projected commission

Status updates from receiving agent

Contact details for receiving agent

Client contact details

Title company contact details

Ability to flag transaction for suspicious activity

Closed deals include everything from the deals in process, as well as:

Actual commission

Payment status with tracking information

Ability to dispute a transaction payment

### Client Functionality

Clients (e.g., homeowners), cannot, in some examples, directly see or interact with their profiles within Platform. In such examples, referring agents create profiles for individual clients when they are creating a referral. Accordingly, the client profile can be like an advertisement for the referral, in that this is what receiving agents will review when deciding to accept the referral.

There can be at least two versions of a client profile in Platform. A first view redacts client contact information when the referral is sent to multiple agents using the agent comparison engine. A second view, with complete client contact information, is revealed to the receiving agent only after all appropriate paperwork has been processed by Platform—and the receiving agent has officially accepted the referral.

Once this happens, the client can be (and, in some examples, is required to be) associated with both agents. Since it is possible that a client might buy or sell multiple houses (particularly if the client is an investor), multiple agents can be associated with a single client. [0089] Referring agents can:

Create, edit, flag, delete client profiles

Expected transaction price

Client demands (type of property, square feet, neighborhood, etc.)

Narrative description of client's preferences, character, needs and desires

Agents can flag a client to Platform. They might choose to do this under the following circumstances:

Incorrect contact information

In this case, the system can be flagged and inquiry can go to the referring agent

Invalid referral (the client isn't really buying/selling a house)

Platform admin can be flagged, human intervention with referring agent

Client is hard to work with

Platform admin can be flagged, human intervention with referring agent

### Agent Transaction Coordinator Functionality

Many agents on both sides of the transaction have transaction coordinators, or other team members, who may provide additional services to clients. Platform can allow for team members associated with agents to provide updates, create client profiles and otherwise interact with Platform on their agent's behalf.

Thus, agent transaction coordinators can do virtually everything agents can do, under their own profiles. However, transaction coordinators may not be visible in an agent search, wherein a referring agent is looking to refer business to a receiving agent.

Yet, an agent transaction coordinator can receive a notice (along with the receiving agent) that a referral is available for review for the principal receiving agent.

### Platform Transaction Manager Functionality

Platform can administer user accounts and transactions with the system. The Platform transaction manager can be responsible for overseeing and supporting individual users within the platform.

The Platform Transaction Manager can:

Create, edit, and flag individual referring and receiving agent, referring broker and client profiles

Manually insert signed paperwork into an agent's profile

Terminate referrals

Create, update and release payment status

Create support ticket

Review, moderate and delete user posts

### Platform Administrator (Super User) Functionality

Platform's super user administrators can do everything Platform's transaction managers can do, but they can have the ability to delete users, tickets and records from the system.

They can also see roll-up reports that show Platform's total commissions from all transactions.

### Title/Escrow Functionality

At this point, title and escrow companies that will disburse funds to as a result of transaction can do so manually by cutting a check to Platform for the referring agent's commission. Platform can then manually disburse funds to the referring broker. In some examples, funds are not sent directly to the referring agent.

However, in examples where funds are submitted electronically to Platform by title companies as a part of the transaction, title/escrow companies can create a profile and form a payment relationship with Platform.

Transactions can be associated with the agent, broker, client and Platform.

Platform can then electronically disburse funds, less its fee, to referring brokers.

### Manual Payment Processing Procedure

The manual payment processing procedure can include:

Title company receives signed referral agreements from Platform transaction manager (e.g., a human)

Title company cuts checks to Platform once funds are cleared out of escrow

Platform receives checks and disburses funds to referring broker

### Document Processing Functionality

When an agent signs up for Platform, a master referral agreement can be automatically generated and distributed to the agent's broker. The referring broker can then sign and return the document electronically to Platform, and the signed, secure document can then be associated with the agent's profile and the broker's profile.

Since a broker can have many agents, there can be a master referral agreement for each agent associated within the broker's directory of agents.

### Two Types of Agreements

Platform can manage at least two types of documents. Two example types of such documents can include:

Master referral agreement between Platform and the referring broker: This can be (and, in some examples, is required to be) signed in order for any transaction to originate through the Platform system.

Agent to agent referral agreement: This document formalizes the relationship between the receiving and referring agent.

Special Situation: Agent Changes Brokerage

When an agent changes brokerages, the master referral agreement stays in place with the brokerage they are leaving. This is because brokers need a record of the agreement, even if the agent has left the firm. However, the agent who is leaving can become inactive with the original referring broker.

Yet if the agent signs on with another broker, the agent can still be considered active in the broader context of Platform.

In this instance, a new master referral agreement with the new broker can be signed and placed in the new broker's account. Thus, an agent might have several master referral agreements associated with their profile, though only one agreement would be active and in force at a time.

Ostensibly, when an agent leaves one brokerage for another, they would update their Platform profile to reflect their new job. Thus, when the profile is updated with a new brokerage, a new master referral agreement can be originated and sent to the new broker. In some examples, an agent cannot be active on Platform unless at least one master agreement is signed, sealed and delivered.

Manual Document Processing Procedure

A manual document processing procedure can include:

Agent creates profile, invites broker to Platform

Broker joins Platform, creates profile

Platform transaction manager is notified of new broker

Platform transaction manager manually sends master referral agreement to broker

Broker signs and returns agreement to Platform

Platform transaction manager uploads signed agreement into agent and broker profile

Referring agent originates deal with receiving agent; sends referral agreement

Receiving agent signs agreement

Platform places signed transaction-level agreement into both agents' profiles

Receiving agent selects title company, updates Platform

Platform sends both signed agreements to title company

Title company disburses funds via physical check to

Platform as per referral agreement terms

Platform pays referring broker

### Other Functionality

Factors that can affect the Platform system can include:

Having active and vetted agents on the platform

Frequent and flawless origination of deals via social networking and agent comparison engine/reviews

Prompt, guaranteed and perfect payment of referral fees

### Vetting Agents

Agents can be (and, in some examples, are required to be) active members of their MLS in order to participate on Platform. They can be (and, in some examples, are required to be) licensed Realtors. Thus, Platform can create a process wherein:

Agent signs up for Platform and creates a profile

Agent inputs their NERDs ID and/or MLS ID

Agent's profile is inactive until . . . .

Platform automatically checks NERDs ID and/or MLS ID to ensure it's valid

If NERDs ID and/or MLS ID is active and in good standing, Platform profile is activated and agent receives a congratulatory email and instructions for completing the profile

If NERDs ID and/or MLS ID is inactive or not verifiable, agent receives message that profile cannot be activated and suggests methods to activate NERDs ID and/or MLS ID

If NERDs ID and/or MLS ID is active, Platform automatically pulls in last three listings from agent's MLS into profile.

Pulling MLS Data into Agent Profile

To make agent profiles more complete and compelling, Platform can pull in verified agents' last three transactions from their local MLS.

Platform also can enable agents to show (if possible) the last transaction the agent did with the client. For example, if the agent is in the process of selling the client's home on their home turf, Platform can show this transaction within the client profile so that other agents can see it.

### Agent Comparison Engine

When a referring agent is contemplating sending a referral out via Platform, the agent has the option to go “shopping” for a receiving agent.

In this case, it doesn't matter whether the referring agent is connected to the receiving agent. An example process includes:

Referring agent enters city or zip code into search bar

Platform presents all available agents in 25 mile radius of location

Referring agent can select up to five receiving agents to compare qualifications

Referring agent can add and delete their picks until they have a “final five”

Referring agent can then send client referral simultaneously to all five agents (or any subset thereof)

Receiving agents receive text message and email that they have received a potential referral

All five agents can reply to referring agent via text or post into referring agent's client profile

Referring agent selects receiving agent

Transaction commences

### Agent Review Engine

Once a transaction has finished, participating agents can review each other. In some examples, only agents who have done business with each other on Platform can review each other.

An example process includes:

Transaction is flagged as complete by Platform transaction manager (e.g., funds have been disbursed)

Platform transaction manager surveys client to ensure customer satisfaction

If positive, Platform transaction manager sends both agents a prompt to review each other

Reviews are posted to a queue, where Platform transaction manager reviews and approves them

Approved reviews are posted to agents' profiles

As another example, categories can be added for reviews, including communication expertise, marketing, and the like.

What is claimed is:

1. A method for communicating information in relation to a subject of reference, the subject of reference characterized by referring information of a referring computing system, the subject of reference characterized by referred information of a referred computing system, the referring computing system 302 lacking omitted information, the omitted information including at least part of the referring information, said method comprising:
first connecting from a referring computing system to a platform computing system;
first communicating from the referring computing system to the platform computing system at least part of the referring information;
first storing at least part of the referring information in memory of the platform computing system;
second connecting from a referring computing system to the platform computing system;
second communicating from the referring computing system to the platform computing system at least part of the referred information;
second storing at least part of the referred information in the memory of the platform computing system;
first querying from the referring computing system to the platform computing system at least one first query criteria, the at least one first query criteria directed to at least part of the referred information;
first retrieving at a processor of the platform computing system from referred information stored in the memory of the platform computing system retrieved information, the retrieved information meeting the at least one first query criteria;
communicating from the platform computing system to the referring computing system returned information, the returned information being at least part of the referred information associated with the retrieved information;
third communicating a first request from the referring computing system to the platform computing system, the first request responsive to the returned information;
fourth communicating a second request from the platform computing system to the referred computing system, the second request responsive to the first request;
fifth communicating a first answer from the referring computing system to the platform computing system, the first answer responsive to the second request;
sixth communicating a second answer from the platform computing system to the referring computing system, the second answer responsive to the first answer;
third storing on the memory of the platform computing system a record of the second answer;
fourth storing on the memory of the platform computing system a record of the first request; and
seventh communicating from the platform computing system to the referred computing system at least part of the omitted information.

2. A method for communicating information according to claim 1 and further comprising:
eighth communicating from the referred computing system to the platform computing system update information, the update information including referred information;
ninth communicating from the platform computing system to the referring computing system the update information.

3. A method for communicating information according to claim 2 and further comprising:
the update information including referred information omitted from the referring computing system.

4. A method for communicating information according to claim 1 and further comprising:
tenth communicating from the referred computing system to the platform computing system event information, the event information relating to a first obligation resultant from the seventh communicating.

5. A method for communicating information according to claim 4 and further comprising:
eleventh communicating from the platform computing system to a recipient computing system the event information, the recipient computing system, the event information relating to a second obligation resultant from the seventh communicating.

6. A method for communicating information according to claim 1 and further comprising:
the at least one first query criteria including:
geographic criteria.

7. A method for communicating information according to claim 1 and further comprising:
the at least one first query criteria including at least one of the following:
geographic criteria, monetary criteria, real property characteristic criteria, referred agent characteristic criteria.

8. A method for communicating information according to claim 7 and further comprising:
the referred agent characteristic criteria including a rating of characteristic criteria.

9. A method for communicating information according to claim 1 and further comprising:
the platform computing system comprising a transaction processing subsystem, the transaction processing subsystem configured for processing documentation of a transaction for real property.

10. A method for communicating information according to claim 1 and further comprising:
the retrieved information being a subset of the referred information.

11. A method for communicating information according to claim 1 and further comprising:
the platform computing system configured to store a plurality of referred information, the plurality of referred information characterizing plural subjects of reference.

12. A system operable for communicating information in relation to a subject of reference, the subject of reference characterized by referring information of a referring computing system, the subject of reference characterized by referred information of a referred computing system, the referring computing system lacking omitted information, the omitted information including at least part of the referring information, said system comprising:
a platform computing system comprising a network adapter, the platform computing system operable for communication via the network adapter with the referring computing system, the platform computing system operable to receive from the referring computing system a first communication including at least part of the referring information, the platform computing system operable to receive from the referring computing system at least part of the referred information;
the platform computing system comprising memory, the memory configured for storing the at least part of the referring information, the memory configured for storing the at least part of the referred information;
the platform computing system comprising a processor in communication with the memory, the processor operable for processing information from the memory upon receipt of a first query from the referring computing system, the first query including at least one first query criteria directed to at least part of the referred information, the processor operable to perform processing in accordance with the first query from the at least part of the referred information stored in the memory to provide retrieved information, the retrieved information meeting the at least one first query criteria;
the platform computing system operable to communicate to the referring computing system returned information, the returned information being at least part of the referred information associated with the retrieved information;
the platform computing system operable to receive from the referring computing system a first request responsive to the returned information, the platform computing system operable to communicate to the referring computing system a second request responsive to the first request;
the platform computing system operable to receive from the referring computing system a first answer responsive to the second request, the platform computing system operable to communicate to the referring computing system a second answer responsive to the first answer;
the platform computing system at the memory operable to store a record of the second answer, the platform computing system at the memory operable to store a record of the first request; and
the platform computing system operable to communicate to the referring computing system at least part of the omitted information.

13. A system according to claim 12 and further comprising:
the platform computing system operable to receive from the referring computing system update information, the update information including referred information, the platform computing system operable to communicate to the referring computing system the update information.

14. A system according to claim 13 and further comprising:
the update information including referred information omitted from the referring computing system.

15. A system according to claim 12 and further comprising:
the platform computing system operable to receive from the referring computer system event information, the event information relating to a first obligation resultant from the platform computing system communicating to the referring computing system at least part of the omitted information.

16. A system according to claim 14 and further comprising:
the platform computing system operable to communicate to a recipient computing system the event information, the recipient computing system being other than the referring computing system, the event information relating to a second obligation resultant from the platform computing system communicating to the referring computing system 302 at least part of the omitted information.

17. A system according to claim 12 and further comprising:
the at least one first query criteria including:
geographic criteria.

18. A system according to claim 12 and further comprising:
the at least one first query criteria including at least one of the following:
geographic criteria, monetary criteria, real property characteristic criteria, referred agent characteristic criteria.

19. A system according to claim 18 and further comprising:
the referred agent characteristic criteria including a rating of characteristic criteria.

20. A system according to claim 12 and further comprising:
the platform computing system comprising a transaction processing subsystem, the transaction processing subsystem operable for processing documentation of a transaction for real property.
